(19) United States
(12) Patent Application Publication
(10) Pub. No.: US 2026/0012548 A1
(43) Pub. Date: Jan. 8, 2026

(54) IMAGE FORMING APPARATUS AND IMAGE FORMING SYSTEM

(71) Applicant: SHARP KABUSHIKI KAISHA, Sakai City (JP)

(72) Inventor: DAISUKE MUKAIYAMA, Sakai City (JP)

(21) Appl. No.: 19/259,389

(22) Filed: Jul. 3, 2025

(30) Foreign Application Priority Data
Jul. 5, 2024 (JP) 2024-109054

(51) Int. Cl. H04N 1/00; G06F 1/3234; H04N 1/327

(52) U.S. Cl. CPC H04N 1/00896; G06F 1/3284; H04N 1/32776; H04N 2201/0075

(57) ABSTRACT

An image forming apparatus comprises, when a communicator receives communication data based on a first communication standard determined in advance from a terminal device in a power saving state, a power supply controller causes the communicator to transition from the power saving state to a silent return state and then causes the communicator to establish connection with the terminal device based on a second communication standard determined in advance, and when the communicator receives a normal return request determined in advance and related to communication based on the second communication standard in the silent return state, the power supply controller causes the communicator to transition from the silent return state to the normal return state.

### CROSS-REFERENCE TO RELATED APPLICATION

The present application claims priority from Japanese Application JP2024-109054, the content of which is hereby incorporated by reference into this application.

### BACKGROUND

### 1. Field

The disclosure relates to an image forming apparatus and an image forming system.

### BACKGROUND ART

In the related art, in order to check an initial position of each unit, to check whether or not each unit is operable, and to perform adjustment operation, the image forming apparatus may be subjected to predetermined print preparation operation when a power supply is turned on from a shut-off state.

On the other hand, there is known an image forming apparatus having a power saving mode transition function of transitioning to a power saving mode when the apparatus is not used for a certain period of time and starting the apparatus at a predetermined timing to suppress power consumption.

In an image forming apparatus having such a power saving mode transition function, although the print preparation operation may be performed when the image forming apparatus returns from the power saving mode and transitions to a normal mode, a large operation sound is generated every time the image forming apparatus returns from the power saving mode, making a user near the apparatus feel uncomfortable in some cases.

In order to solve such a problem, as an image forming apparatus that suppresses operation sound when the image forming apparatus transitions from the power saving mode to the normal mode, there is typically known an image forming apparatus including a timer that measures a time period during which the image forming apparatus is set in the power saving mode. The image forming apparatus does not allow each unit to perform print preparation operation even when a mode switch switches the mode from the power saving mode to the normal mode in a case where the measured time period is smaller than a threshold value.

There is also known a technique of, when the apparatus state of a multifunctional peripheral (MFP) is a hardware-off state (a state in which the power supply is not turned on) or a software-off state (a state in which the power supply is turned on but a main program is not started) and when a mobile communication terminal device receives job information transmitted through NFC communication, performing start processing of the MFP to return the state of the MFP to a normal state (a state in which the program is normally started).

### SUMMARY

On the other hand, in a case where the image forming apparatus is allowed to return from the power saving state to the normal state through the NFC communication and when the print preparation operation is always performed after the return, a large operation sound is generated every time of the print preparation operation, causing a problem. In particular, even when a job not accompanied by printing is performed, wasteful print preparation operation is performed, causing a problem.

The disclosure has been made in view of the above circumstances, and an object of the disclosure is to provide an image forming apparatus and an image forming system that are highly convenient for a user by reducing wasteful print preparation operation when returning from a power saving state as compared to the related art.

The disclosure provides an image forming apparatus including a communicator that transmits and receives various types of data to and from a terminal device existing outside the image forming apparatus, an image former that forms an image, one or more controllers that control the communicator and the image former, and a power supply controller that controls a power to be supplied to each of the communicator, the image former, and the one or more controllers, causes each of the communicator, the image former, and the one or more controllers to transition to a power saving state when a predetermined power saving transition condition is satisfied, causes each of the communicator, the image former, and the one or more controllers to transition to a silent return state not accompanied by activation of at least the image former when a predetermined silent return condition is satisfied in the power saving state, and causes each of the communicator, the image former, and the one or more controllers to return to a normal return state when a predetermined normal return condition is satisfied in the silent return state. When the communicator receives communication data based on a first communication standard determined in advance from the terminal device in the power saving state, the power supply controller causes the communicator to transition from the power saving state to the silent return state and then causes the communicator to establish connection with the terminal device based on a second communication standard determined in advance. When the communicator receives a normal return request determined in advance and related to communication based on the second communication standard in the silent return state, the power supply controller causes the communicator to transition from the silent return state to the normal return state. Further, the disclosure provides an image forming system including the image forming apparatus and the terminal device that are communicably connected to each other via a network. The terminal device includes a terminal storage that stores a program of a job application determined in advance, a terminal display that displays various types of information to a user, a terminal communicator that transmits and receives various types of data to and from the image forming apparatus, and a terminal controller that controls the terminal storage, the terminal display, and the terminal communicator. The terminal controller causes the terminal display to display a first job selection screen after start of the job application, causes the terminal communicator to establish communication with the image forming apparatus based on the second communication standard when communication data based on the first communication standard is received from the image forming apparatus, and then causes the terminal display to display a second job selection screen including a message indicating completion of connection establishment with the image forming apparatus.

In the disclosure, the “image forming apparatus” is an apparatus that forms and outputs an image, such as a copy machine or a multi-function machine having a copier function such as a printer using an electrophotographic scheme for forming an image with toner, or a multifunctional peripheral (MFP) including functions other than copying. The “terminal device” is, for example, a mobile information terminal such as a smartphone or a tablet.

According to the disclosure, when the communication data based on the first communication standard is received in the power saving state, the image forming apparatus is shifted from the power saving state to the silent return state, and when the normal return request is received through the communication based on the second communication standard in the silent return state, the image forming apparatus is shifted from the silent return state to the normal return state, reducing unnecessary print preparation operation at the time of returning from the power saving state as compared with the related art and thereby implementing the image forming apparatus and the image forming system with high convenience for a user.

### BRIEF DESCRIPTION OF THE DRAWINGS

FIG. 1 is an explanatory diagram illustrating an example of an image forming system according to a first embodiment of the disclosure.

FIG. 2 is a block diagram illustrating a schematic configuration of a digital multi-function machine in FIG. 1.

FIG. 3 is a block diagram illustrating a schematic configuration of a user terminal in FIG. 1.

FIG. 4 is a flowchart illustrating an example of return processing from a power saving state of the digital multi-function machine in FIG. 1.

FIG. 5A is an explanatory diagram illustrating a relationship between communication states of the digital multi-function machine and the user terminal in FIG. 1 and a state of the digital multi-function machine and illustrating a case where the digital multi-function machine is in a normal return state.

FIG. 5B is an explanatory diagram illustrating a relationship between communication states of the digital multi-function machine and the user terminal in FIG. 1 and a state of the digital multi-function machine and illustrating a case where the digital multi-function machine is in a silent return state.

FIG. 5C is an explanatory diagram illustrating a relationship between communication states of the digital multi-function machine and the user terminal in FIG. 1 and a state of the digital multi-function machine and illustrating a case where the digital multi-function machine is in a power saving state.

FIG. 6 is a flowchart illustrating an example of a process of displaying a job selection screen 1 when the user terminal in FIG. 1 starts a print application.

FIG. 7 illustrates an example of a screen for a print application displayed on a display of the user terminal in FIG. 1.

FIG. 8 illustrates an example of the job selection screen 1 displayed on the display of the user terminal in FIG. 1.

FIG. 9 is a flowchart illustrating an example of a process of displaying a job selection screen 2 after reception of communication data based on NFC by the user terminal in FIG. 1.

FIG. 10 illustrates an example of an NFC connection waiting screen displayed on the display of the user terminal in FIG. 1.

FIG. 11 illustrates an example of the job selection screen 2 displayed on the display of the user terminal in FIG. 1.

FIG. 12 is a flowchart illustrating an example of processing performed when a scan button is pressed on the job selection screen 1 of the user terminal in FIG. 1.

FIG. 13 illustrates an example of a scan screen displayed on the display of the user terminal in FIG. 1.

FIG. 14 is a flowchart illustrating an example of processing performed when a scan button is pressed on the job selection screen 2 of the user terminal in FIG. 1.

FIG. 15 is a flowchart illustrating an example of processing when a print button is pressed on the job selection screen 1 of the user terminal in FIG. 1.

FIG. 16 illustrates an example of a data selection screen displayed on the display of the user terminal in FIG. 1.

FIG. 17 illustrates an example of a print screen displayed on the display of the user terminal in FIG. 1.

FIG. 18 is a flowchart illustrating an example of processing performed when a print button is pressed on the job selection screen 2 of the user terminal in FIG. 1.

### DESCRIPTION OF EMBODIMENTS

Further, preferred aspects of the disclosure will be described.

For the image forming apparatus according to the disclosure, the first communication standard may be NFC, and the second communication standard may be a communication standard other than NFC.

“NFC” is the near field communication standard, and for example, when a terminal device is touched on (or brought close to) a predetermined NFC touch area of an image forming apparatus, mutual communication becomes possible between the terminal device and the image forming apparatus. Examples of the “communication standard other than NFC” include a wireless communication standard such as Wi-Fi.

In this way, when receiving communication data based on NFC in the power saving state, the image forming apparatus is shifted from the power saving state to the silent return state, and when receiving the normal return request in the silent return state by communication based on the communication standard other than NFC, the image forming apparatus is shifted from the silent return state to the normal return state, reducing unnecessary print preparation operation at the time of returning from the power saving state as compared with the typical image forming apparatus and thereby implementing the image forming apparatus with high convenience for the user.

In the image forming apparatus according to the disclosure, in the power saving state, the power supply controller may supply power to only a communication circuit corresponding to the first communication standard in the communicator and thus activate the communication circuit.

In this way, even in the power saving state, the communicator receives the communication data based on the first communication standard, causing transition from the power saving state to the silent return state. Thus, the image forming apparatus with high convenience for the user can be implemented by reducing unnecessary print preparation operation at the time of returning from the power saving state as compared with the related art.

The image forming system according to the disclosure may further include a terminal operation unit that receives operation of a user, and the terminal controller may cause the terminal display to display a message indicating that communication connection with the image forming apparatus based on the first communication standard is to be established when the terminal operation unit receives a selection of a job on the first job selection screen after the start of the job application.

The “message indicating that communication connection with the image forming apparatus based on the first communication standard is to be established” is, for example, a message for prompting the user to touch the predetermined NFC touch area of the image forming apparatus with the terminal device, such as “Touch NFC”, in a case where the first communication standard is NFC.

In this way, since the message indicating that the communication connection based on the first communication standard is to be established is displayed in a case where the terminal device has received the selection of the job, the image forming system with high convenience for the user can be implemented by shifting the state from the power saving state to the silent return state in a case where the communication data based on the first communication standard is received in the power saving state and thus reducing the unnecessary print preparation operation at the time of returning from the power saving state as compared with the related art.

Further, in the image forming system according to the disclosure, when the terminal operation unit receives a selection of a job accompanied by operation of the image former after completion of communication establishment with the image forming apparatus based on the second communication standard, the terminal controller may cause the terminal communicator to transmit the normal return request to the image forming apparatus based on the second communication standard and then cause the terminal display to display an execution screen of the job.

The “selection of the job accompanied by the operation of the image former” is, for example, a print job.

In this way, in the terminal device, after the completion of the communication establishment with the image forming apparatus based on the second communication standard and when the selection of the job accompanied by the operation of the image former is received, the normal return request is transmitted to the image forming apparatus based on the second communication standard, and thus, the image forming system with high convenience for the user can be implemented by reducing unnecessary print preparation operation at the time of returning from the power saving state as compared to the related art.

Hereinafter, the disclosure will be described in further detail using the drawings. Note that the following description is in all aspects illustrative and it should not be understood as limiting the disclosure.

### First Embodiment

### Configuration of Image Forming System 100

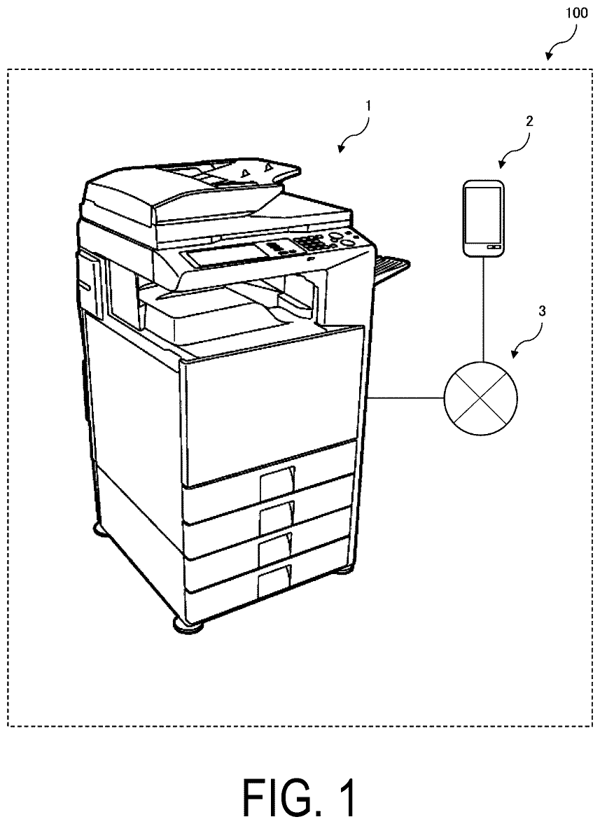

An image forming system 100 including a digital multi-function machine 1 according to an embodiment of the image forming apparatus of the disclosure and a user terminal 2 according to an embodiment of the terminal device of the disclosure will be described based on FIG. 1 to FIG. 3.

FIG. 1 is an explanatory diagram illustrating an example of the image forming system 100 according to a first embodiment of the disclosure.

As illustrated in FIG. 1, the image forming system 100 includes the digital multi-function machine 1, the user terminal 2, and a network 3.

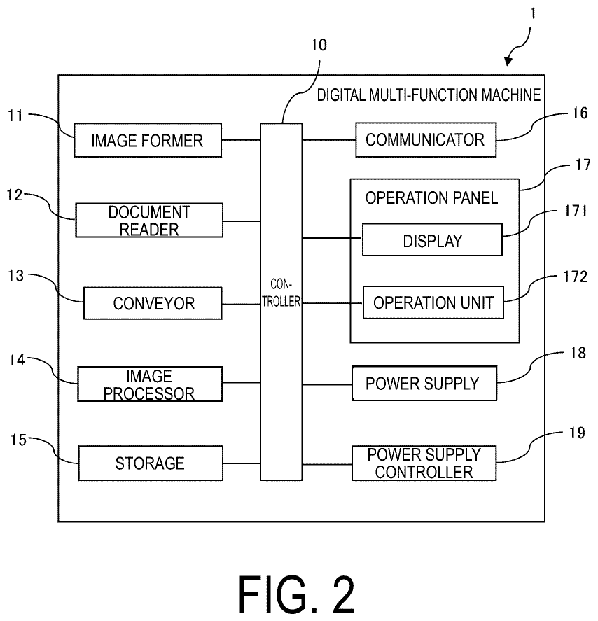

FIG. 2 is a block diagram illustrating a schematic configuration of the digital multi-function machine 1 in FIG. 1.

The digital multi-function machine 1 is an apparatus, such as a multi-function machine or a multifunctional peripheral (MFP), that performs digital processing on image data and then outputs the processed image data and has a copier function, a printer function, a scanner function, and a facsimile function.

As illustrated in FIG. 2, the digital multi-function machine 1 includes one or more controllers 10, an image former 11, a document reader 12, a conveyor 13, an image processor 14, a storage 15, a communicator 16, an operation panel 17, a power supply 18, and a power supply controller 19.

Hereinafter, constituent elements of the digital multi-function machine 1 will be described.

The one or more controllers 10 integrally control the digital multi-function machine 1 and include at least one central processing unit (CPU), at least one random access memory (RAM), at least one read only memory (ROM), various interface circuits, and the like.

The one or more controllers 10 perform monitoring and controlling of detection of each sensor and all loads such as a motor, a clutch, and the operation panel 17 in order to control operation of the entire digital multi-function machine 1.

The image former 11 is a unit that prints and outputs, on a recording sheet, image data generated by the image processor 14.

The image former 11 performs predetermined initial operation at the time of turning on the power supply from a shut-off state or during normal return processing in order to check the initial position of each unit, to check whether or not each unit is operable, and to perform adjustment operation.

The document reader 12 is a unit that detects and optically reads a document placed on a document table or a document placed on an automatic document feeder (ADF) and a predetermined document tray and conveyed by the conveyor 13 and then generates image data.

The conveyor 13 is a unit that conveys, to the image former 11, a recording sheet stored in a sheet feeding cassette or a manual feeding tray to discharge the recording sheet from a sheet discharge tray.

Additionally, in an automatic reading mode, the conveyor 13 sequentially conveys the document placed on the ADF or the document tray toward the document reader 12.

The image processor 14 is a unit that converts an image on the document read by the document reader 12 into an appropriate electric signal to generate image data. Further, the image processor 14 is a unit that performs processing suitable for output such as enlargement/reduction of an image displayed on a display 171 based on a command received by an operation unit 172.

The storage 15 is an element or a storage medium that stores information required to enable various functions of the digital multi-function machine 1, a control program, and the like. For example, a semiconductor device such as a RAM or a ROM or a storage medium such as a hard disk, a flash storage, or a solid state drive (SSD) is used.

Note that the program and the data may be held in different devices. For example, the region for holding the data may be constituted by a hard disk drive and the region for holding the program may be constituted by a flash storage.

The communicator 16 is a unit that performs communication with the user terminal 2, a computer, a mobile information terminal, an external information processing device, a facsimile device, or the like via a network or the like and transmits and receives various types of information such as emails and faxes to and from these external communication devices.

The communicator 16 performs communication based on a predetermined first communication standard (for example, NFC) and communication based on a predetermined second communication standard (for example, Wi-Fi).

In a case where the first communication standard is NFC, when a user touches a predetermined NFC touch area of the digital multi-function machine 1 with the user terminal 2, communication with the user terminal 2 based on NFC becomes possible.

The operation panel 17 is a unit that displays various types of information and receives a command from the user using a touch panel function thereof.

The operation panel 17 includes a display panel including a liquid crystal panel or the like and a capacitance type touch panel or the like that is disposed in a superimposed manner over the display panel and detects a position touched with a finger. The operation panel 17 includes the display 171 and the operation unit 172.

The display 171 is a display device such as a monitor or a line display that is constituted by, for example, a CRT display, a liquid crystal display, or an EL display, and that is used for an operating system and application software displaying electronic data such as processing states.

The one or more controllers 10 perform display of the operation and the state of the digital multi-function machine 1 through the display 171.

The operation unit 172 is an interface for operating the digital multi-function machine 1 and is a unit that receives a command from the user.

The power supply 18 supplies a power to a circuit of each unit included in the digital multi-function machine 1. As the power supply 18, for example, an AT power supply, an ATX power supply, an SFX power supply, or the like is used.

The power supply controller 19 controls the power supply 18 to be turned on and off, thereby controlling the power to be supplied to the circuit of each unit of the digital multi-function machine 1.

The power supply controller 19 causes the digital multi-function machine 1 to transition to the power saving state when a predetermined power saving state transition condition is satisfied, such as when no operation is performed from the operation unit 172 for a certain period of time. Further, the power supply controller 19 causes the digital multi-function machine 1 to transition to the silent return state when a predetermined silent return condition is satisfied, such as when NFC communication is detected in the power saving state. Further, the power supply controller 19 causes the digital multi-function machine 1 to transition to the normal return state when a predetermined normal return condition is satisfied, such as when the communicator 16 receives a normal return request through Wi-Fi communication in the silent return state.

The power supply controller 19 causes the digital multi-function machine 1 to return from a sleep state to a standby state based on a predetermined return condition, such as when a human presence sensor detects a person.

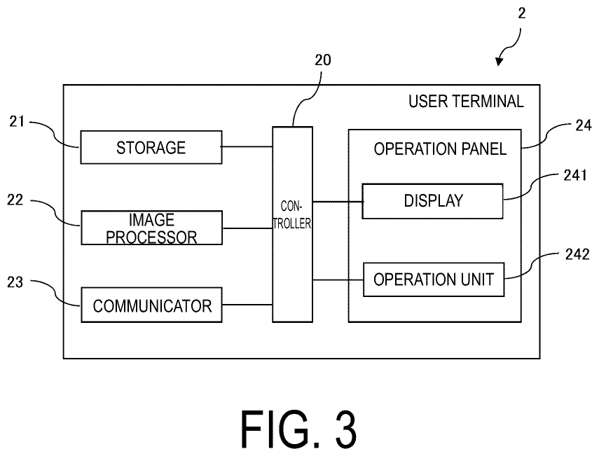

FIG. 3 is a block diagram illustrating a schematic configuration of the user terminal 2 in FIG. 1.

As illustrated in FIG. 3, the user terminal 2 includes a controller 20, a storage 21, an image processor 22, a communicator 23, and an operation panel 24.

The controller 20 integrally controls the user terminal 2 and includes a CPU, a RAM, a ROM, various interface circuits and the like.

The storage 21 is an element or a storage medium that stores information, a control program, and the like required to enable various functions of the user terminal 2. For example, a semiconductor device such as a RAM or a ROM or a storage medium such as a hard disk, a flash storage, or an SSD is used.

The image processor 22 is a unit that performs processing so as to be suitable for output such as enlargement/reduction of an image displayed on a display 241 based on a command received by an operation unit 242.

The communicator 23 is a unit that performs communication with the digital multi-function machine 1 and the like via the network and transmits and receives various kinds of information. The communicator 23 performs communication based on the first communication standard (for example, NFC) and communication based on the second communication standard (for example, Wi-Fi).

In a case where the first communication standard is NFC, when the user touches the predetermined NFC touch area of the digital multi-function machine 1 with the user terminal 2, communication with the digital multi-function machine 1 based on NFC becomes possible.

The operation panel 24 includes a display panel including a liquid crystal panel or the like and a capacitance type touch panel that is disposed in a superimposed manner over the display panel and that detects a position touched with a finger. The operation panel 24 includes the display 241 and the operation unit 242.

The display 241 is a display device such as a monitor or a line display that is constituted by, for example, a CRT display, a liquid crystal display, an EL display, or the like, and that is used for an operating system and application software displaying electronic data such as processing states. The controller 20 causes the display 241 to display operation and a state of the user terminal 2.

The operation unit 242 is an interface for operating the user terminal 2 and is a unit that receives a command from the user.

Return Processing from Power Saving State of Digital Multi-function Machine 1 of First Embodiment of the Disclosure

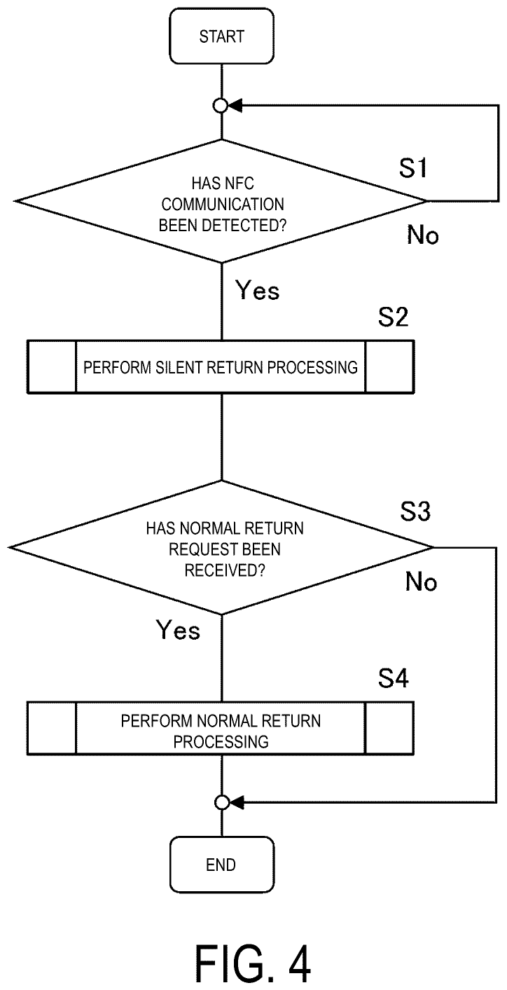

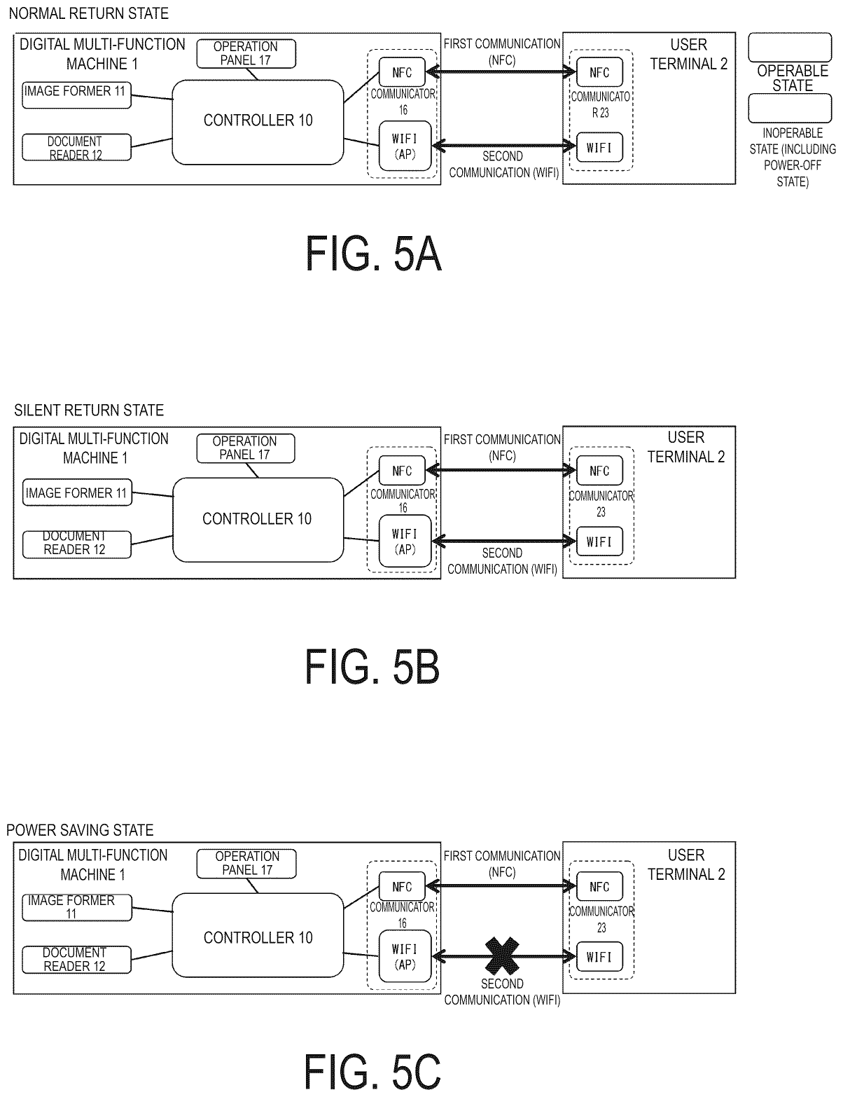

Next, return processing from the power saving state of the digital multi-function machine 1 according to the first embodiment of the disclosure will be described based on FIG. 4 and FIGS. 5A to 5C.

FIG. 4 is a flowchart illustrating an example of the return processing from the power saving state of the digital multi-function machine 1 in FIG. 1.

In the first embodiment, the first communication standard is NFC, and the second communication standard is Wi-Fi.

In step S1 in FIG. 4, the one or more controllers 10 of the digital multi-function machine 1 determine whether or not the communicator 16 detects NFC communication (step S1).

When the communicator 16 detects the NFC communication (when the determination in step S1 is Yes), the one or more controllers 10 perform silent return processing in step S2 (step S2).

The one or more controllers 10 perform, as the silent return processing, predetermined processing that does not accompany a loud operation sound, such as turning on the screen of the operation panel 17, causing the document reader 12 to perform preparation operation for the scanner or the like, or starting an access point (AP) mode of Wi-Fi.

Subsequently, in step S3, the one or more controllers 10 determine whether or not the communicator 16 has received a normal return request based on Wi-Fi communication (step S3).

In a case where the communicator 16 has received the normal return request (when the determination in step S3 is Yes), the one or more controllers 10 perform normal return processing in step S4.

The one or more controllers 10 perform, as the normal return processing, predetermined processing accompanied by a loud operation sound, such as print preparation operation, on the image former 11.

On the other hand, when the communicator 16 does not receive the normal return request (when the determination in step S3 is No), the one or more controllers 10 end the processing.

FIGS. 5A to 5C are explanatory diagrams illustrating relationships between communication states of the digital multi-function machine 1 and the user terminal 2 in FIG. 1 and states of the digital multi-function machine 1. FIG. 5A illustrates a case where the digital multi-function machine 1 is in the normal return state, FIG. 5B illustrates a case where the digital multi-function machine 1 is in the silent return state, and FIG. 5C illustrates a case where the digital multi-function machine 1 is in the power saving state.

In FIGS. 5A to 5C, constituent elements of the digital multi-function machine 1 illustrated in gray (shaded) indicate that the constituent elements are in an inoperable state (including power-off state), and the other constituent elements illustrated in white indicate that the constituent elements are in an operable state.

The power supply controller 19 controls the power supply 18 to be turned on or off and thus controls the power to be supplied to the circuit of each unit of the digital multi-function machine 1, thereby switching the inoperable state and the operable state of each of the constituent elements as illustrated in FIGS. 5A to 5C.

As illustrated in FIG. 5A, when the digital multi-function machine 1 is in the normal return state, all the constituent elements are in the operable state. In this case, the communicator 16 can perform both the first communication based on NFC and the second communication based on Wi-Fi with the communicator 23 of the user terminal 2.

On the other hand, as illustrated in FIG. 5B, when the digital multi-function machine 1 is in the silent return state, only the image former 11 is in the inoperable state.

Additionally, as illustrated in FIG. 5C, when the digital multi-function machine 1 is in the power saving state, Wi-Fi (AP) among the image former 11, the document reader 12, the operation panel 17, and the communicator 16 is in the inoperable state. In this case, the communicator 16 can perform the first communication with the communicator 23 of the user terminal 2 based on NFC, but cannot perform the second communication based on Wi-Fi.

Thus, even when the digital multi-function machine 1 is in the power saving state, as illustrated in steps S1 and S2 of FIG. 4, the silent return processing is performed by performing the first communication with the communicator 23 of the user terminal 2 based on NFC, allowing start of Wi-Fi (AP).

Then, after Wi-Fi (AP) is started, as illustrated in steps S3 and S4, the normal return processing is performed by the Wi-Fi communication with the communicator 23 of the user terminal 2, thus allowing transition from the silent return state to the normal return state.

In this way, it is possible to return from the power saving state in two stages: the silent return processing and the normal return processing, based on the communication standards (the first communication standard and the second communication standard) with the communicator 23 of the user terminal 2. In particular, when a job such as scanning not requiring the print preparation operation is performed, the job can be executed while the silent state is being maintained, thus allowing the digital multi-function machine 1 to be implemented with high convenience for the user.

### Job Selection and Execution Processing for Digital Multi-function Machine 1 by Using Print Application of User Terminal 2 of First Embodiment of the Disclosure

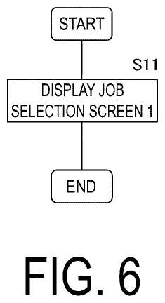

Next, job selection and execution processing for the digital multi-function machine 1 by using a print application of the user terminal 2 according to the first embodiment of the disclosure will be described with reference to FIG. 6 to FIG. 18.

FIG. 6 is a flowchart illustrating an example of a process of displaying the job selection screen 1 at the time of start of the print application of the user terminal 2 in FIG. 1.

When the print application of the user terminal 2 is started, in step S11 of FIG. 6, the controller 20 of the user terminal 2 causes the display 241 to display the job selection screen 1 (step S11) and ends the processing.

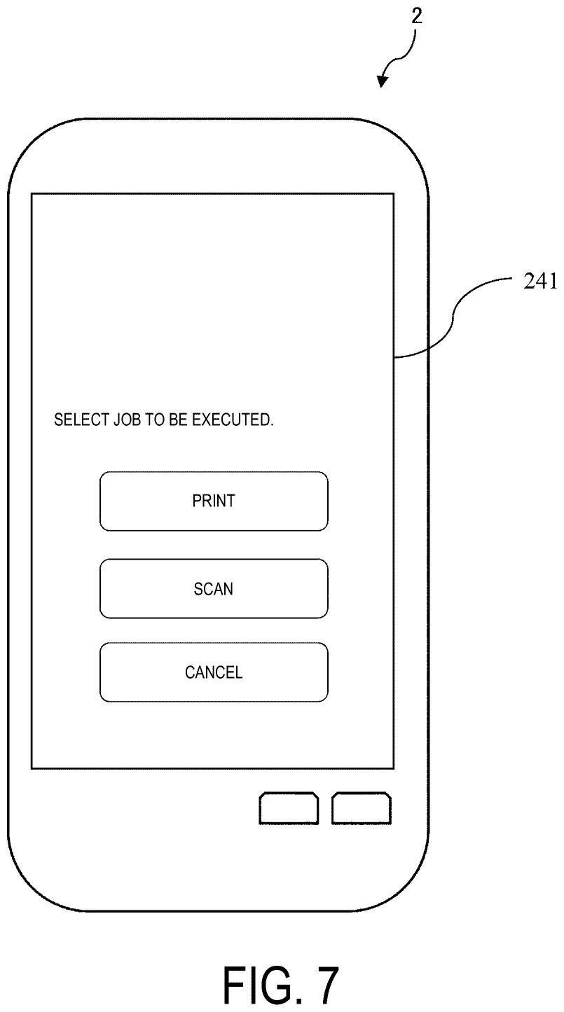

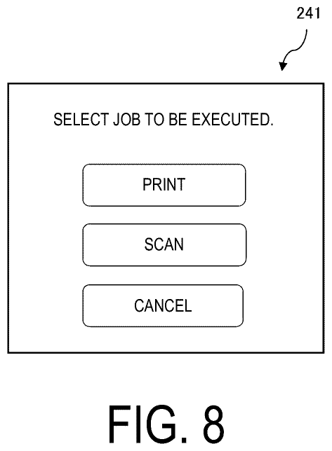

FIG. 7 is an example of a screen of the print application displayed on the display 241 of the user terminal 2 in FIG. 1. FIG. 8 is an example of the job selection screen 1 displayed on the display 241 of the user terminal 2 in FIG. 1.

As illustrated in FIG. 8, in the job selection screen 1, “Print”, “Scan”, and “Cancel” buttons are displayed on the display 241 together with a message of “Select a job to be executed”.

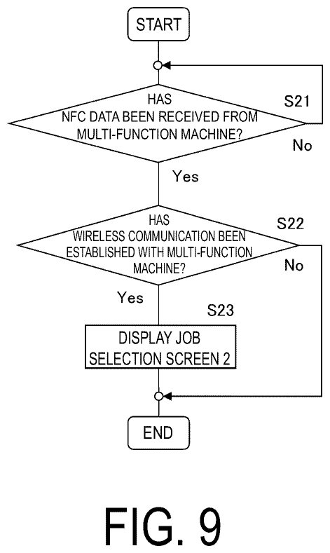

FIG. 9 is a flowchart illustrating an example of a process of displaying the job selection screen 2 after the user terminal 2 in FIG. 1 receives communication data based on NFC.

After displaying the job selection screen 1, in step S21 in FIG. 9, the controller 20 determines whether or not the communicator 23 has received communication data based on NFC from the digital multi-function machine 1 (step S21).

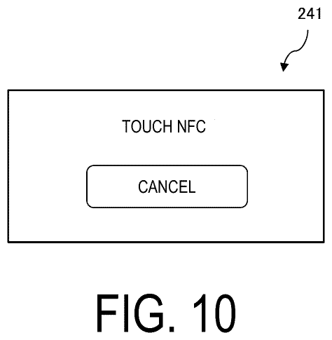

FIG. 10 is an example of an NFC connection waiting screen displayed on the display 241 of the user terminal 2 in FIG. 1. As illustrated in FIG. 10, a “Cancel” button is displayed on the display 241 together with a message “Touch NFC”.

When the user touches the predetermined NFC touch area of the digital multi-function machine 1 with the user terminal 2, the first communication based on NFC is started. On the other hand, when the user presses the “Cancel” button, the NFC connection waiting screen is deleted.

In a case where the communicator 23 has not received communication data based on NFC from the digital multi-function machine 1 (when the determination of step S21 is No), the controller 20 returns the processing to the determination in step S21.

On the other hand, in a case where the communicator 23 has received communication data based on NFC from the digital multi-function machine 1 (when the determination in step S21 is Yes), the controller 20 determines whether or not wireless communication has been established with the digital multi-function machine 1 based on Wi-Fi in step S22 (step S22).

When the wireless communication has been established with the digital multi-function machine 1 (when the determination in step S22 is Yes), the controller 20 displays the job selection screen 2 on the display 241 in step S23 (step S23) and then ends the processing.

On the other hand, when the wireless communication has not been established with the digital multi-function machine 1 (when the determination in step S22 is No), the controller 20 ends the processing.

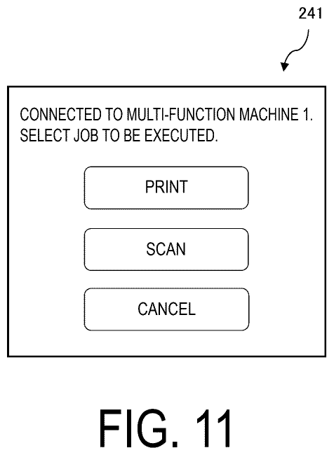

FIG. 11 is an example of the job selection screen 2 displayed on the display 241 of the user terminal 2 in FIG. 1. As illustrated in FIG. 11, in the job selection screen 2, “Print”, “Scan”, and “Cancel” buttons are displayed on the display 241 together with a message of “Connected to Multi-function Machine 1. Select a job to be executed”.

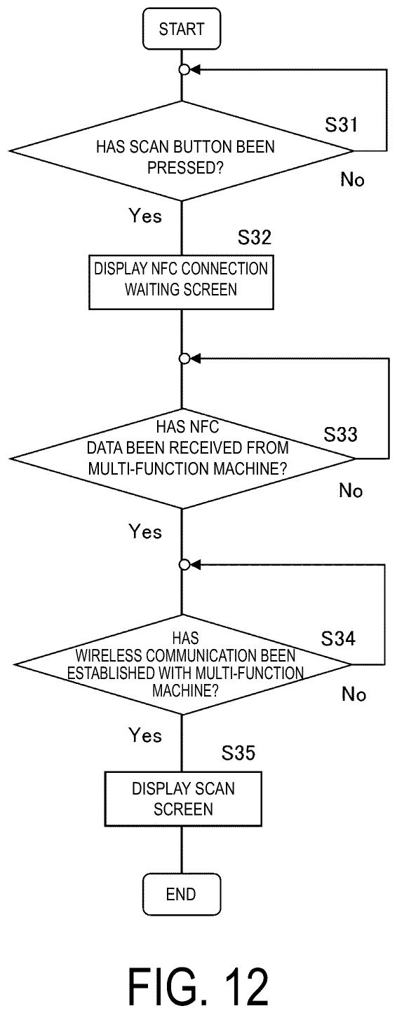

Case of Executing Scan Job on Job Selection Screen 1 FIG. 12 is a flowchart illustrating an example of processing when the scan button is pressed on the job selection screen 1 of the user terminal 2 in FIG. 1.

The controller 20 determines whether or not the scan button has been pressed in step S31 in FIG. 12 (step S31). In a case where the scan button has not been pressed (when the determination in step S31 is No), the controller 20 returns the processing to the determination in step S31.

On the other hand, in a case where the scan button has been pressed (when the determination in step S31 is Yes), in step S32, the controller 20 causes the display 241 to display the NFC connection waiting screen (step S32).

Next, in step S33, the controller 20 determines whether or not the communicator 23 has received communication data based on NFC from the digital multi-function machine 1 (step S33). In a case where the communicator 23 has not received communication data based on NFC from the digital multi-function machine 1 (when the determination in step S33 is No), the controller 20 returns the processing to the determination in step S33.

On the other hand, in a case where the communicator 23 has received communication data based on NFC from the digital multi-function machine 1 (when the determination in step S33 is Yes), in step S34, the controller 20 determines whether or not wireless communication has been established based on Wi-Fi with the digital multi-function machine 1 (step S34). In a case where the wireless communication has not been established with the digital multi-function machine 1 (when the determination in step S34 is No), the controller 20 returns the processing to the determination in step S34.

On the other hand, in a case where the wireless communication has been established with the digital multi-function machine 1 (when the determination in step S34 is Yes), the controller 20 causes the display 241 to display a scan screen in step S35 (step S35) and then ends the processing.

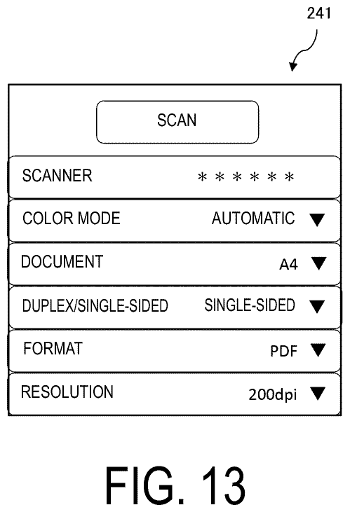

FIG. 13 is an example of the scan screen displayed on the display 241 of the user terminal 2 in FIG. 1. In the example of FIG. 13, a “Scan” button is displayed on the display 241, and scan settings (“Scanner *****”, “Color Mode Auto”, “Document A4”, “Duplex/Single-Sided Single-Sided”, “Format PDF”, and “Resolution 200 dpi”) are displayed below the button. When the user presses the “Scan” button after setting the scan settings, the scan job is started in the digital multi-function machine 1.

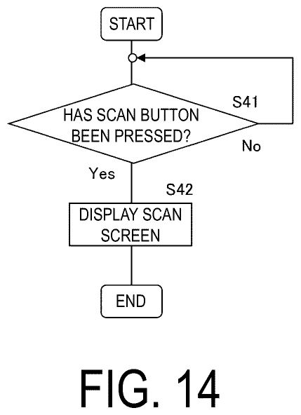

Case of Executing Scan Job by Using Job Selection Screen 2 FIG. 14 is a flowchart illustrating an example of processing performed when the scan button is pressed on the job selection screen 2 of the user terminal 2 in FIG. 1.

The controller 20 determines whether or not the scan button has been pressed in step S41 in FIG. 14 (step S41). In a case where the scan button has not been pressed (when the determination in step S41 is No), the controller 20 returns the processing to the determination in step S41.

On the other hand, in a case where the scan button has been pressed (when the determination in step S41 is Yes), in step S42, the controller 20 causes the display 241 to display the scan screen (step S42) and then ends the processing.

### Case of Executing Print Job by Using Job Selection Screen 1

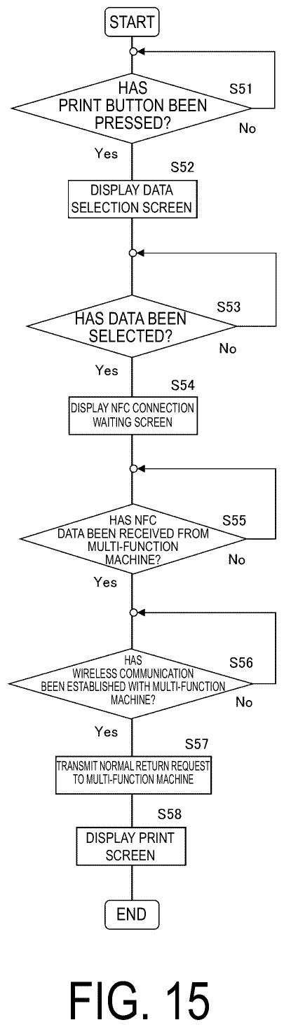

FIG. 15 is a flowchart illustrating an example of processing in a case where the print button has been pressed on the job selection screen 1 of the user terminal 2 in FIG. 1.

The controller 20 determines whether or not a print button has been pressed in step S51 in FIG. 15 (step S51). In a case where the print button has not been pressed (when the determination in step S51 is No), the controller 20 returns the processing to the determination in step S51.

In a case where the print button has not been pressed (when the determination in step S51 is Yes), in step S52, the controller 20 causes the display 241 to display a data selection screen (step S52).

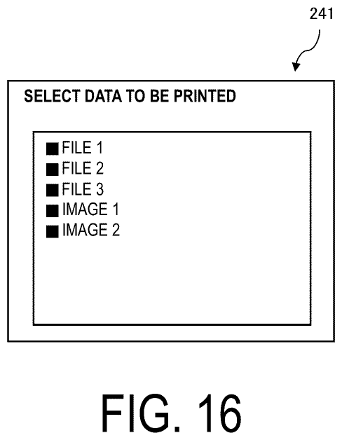

FIG. 16 is an example of the data selection screen displayed on the display 241 of the user terminal 2 in FIG. 1. In the example of FIG. 16, data to be selected (“File 1”, “File 2”, “File 3”, “Image 1”, and “Image 2”) are displayed on the display 241 below a message “Select print data”.

Subsequently, the controller 20 determines whether or not the data has been selected in step S53 in FIG. 15 (step S53). In a case where the data has not been selected (when the determination in step S53 is No), the controller 20 returns the processing to step S53.

In a case where the data has been selected (when the determination in step S53 is Yes), in step S54, the controller 20 causes the display 241 to display an NFC connection waiting screen (step S54).

Next, in step S55, the controller 20 determines whether or not the communicator 23 has received communication data based on NFC from the digital multi-function machine 1 (step S55). In a case where the communicator 23 has not received communication data based on NFC from the digital multi-function machine 1 (when the determination in step S55 is No), the controller 20 returns the processing to the determination in step S55.

On the other hand, in a case where the communicator 23 has received communication data based on NFC from the digital multi-function machine 1 (when the determination in step S55 is Yes), in step S56, the controller 20 determines whether or not wireless communication based on Wi-Fi has been established with the digital multi-function machine 1 (step S56). In a case where the wireless communication has not been established with the digital multi-function machine 1 (when the determination in step S56 is No), the controller 20 returns the processing to the determination in step S56.

On the other hand, in a case where the wireless communication has been established with the digital multi-function machine 1 (when the determination in step S56 is Yes), in step S57, the controller 20 causes the communicator 23 to transmit a normal return request to the digital multi-function machine 1 through the Wi-Fi communication (step S57).

Thereafter, in step S58, the controller 20 causes the display 241 to display a print screen (step S58) and then ends the processing.

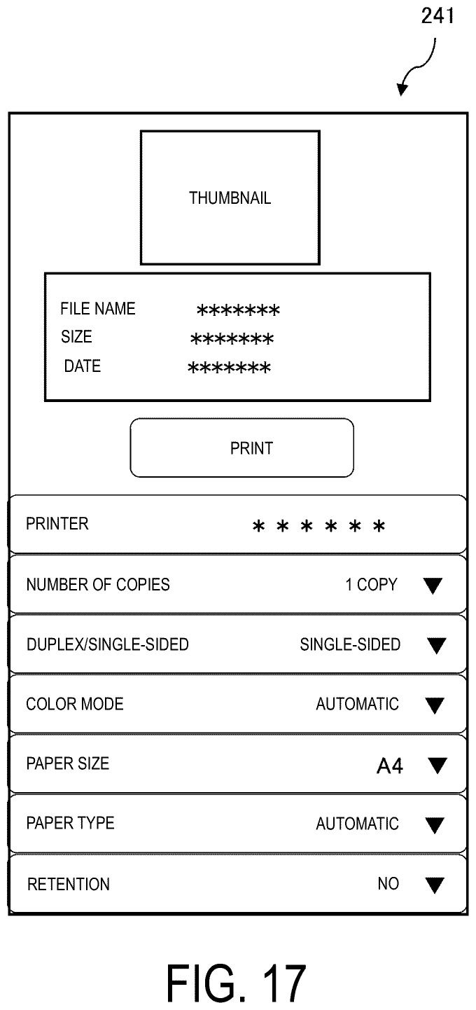

FIG. 17 is an example of the print screen displayed on the display 241 of the user terminal 2 in FIG. 1. In the example of FIG. 17, a “Print” button is displayed on the display 241, and “Thumbnail” and data information (“Filename”, “Size”, and “Date”) are displayed above the button, and print settings (“Printer *****”, “Number of copies 1 copy”, “Duplex/Single-Sided Single-Sided”, “Color Mode Automatic”, “Paper Size A4”, “Paper Type Automatic”, and “Retention No”) are displayed below the screen. When the user presses the “Print” button after setting the print settings, the digital multi-function machine 1 starts the print job.

### Case of Executing Print Job by Using Job Selection Screen 2

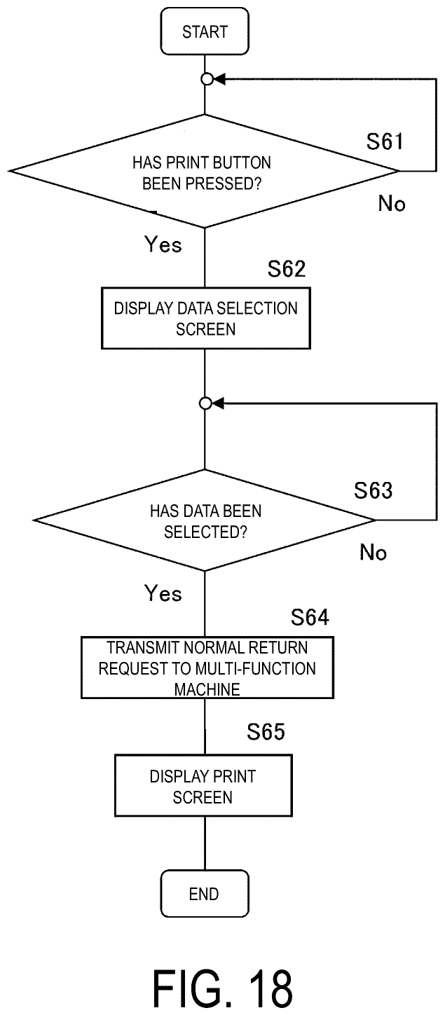

FIG. 18 is a flowchart illustrating an example of processing when the print button is pressed on the job selection screen 2 of the user terminal 2 in FIG. 1.

The controller 20 determines whether or not the print button has been pressed in step S61 in FIG. 18 (step S61). In a case where the print button has not been pressed (when the determination in step S61 is No), the controller 20 returns the processing to the determination in step S61.

On the other hand, in a case where the print button has not been pressed (when the determination in step S61 is Yes), in step S62, the controller 20 causes the display 241 to display a data selection screen (step S62).

Subsequently, in step S63, the controller 20 determines whether or not data has been selected (step S63). In a case where the data has not been selected (when the determination in step S63 is No), the controller 20 returns the processing to step S63.

On the other hand, in a case where the data has been selected (when the determination in step S63 is Yes), in step S64, the controller 20 causes the communicator 23 to transmit a normal return request to the digital multi-function machine 1 through Wi-Fi communication (step S64).

Thereafter, in step S65, the controller 20 causes the display 241 to display the print screen (step S65) and then ends the processing.

In this way, when communication data based on NFC is received in the power saving state, the transition from the power saving state to the silent return state is performed, and when the normal return request is received through Wi-Fi communication in the silent return state, the transition from the silent return state to the normal return state is performed, so that the digital multi-function machine 1 can be implemented with high convenience for the user by reducing wasteful print preparation operation at the time of returning from the power saving state as compared with the related art.

Preferred aspects of the disclosure include combinations of any of the multiple aspects described above. Various modifications of the disclosure are also possible as well as the aforementioned embodiments. It should not be understood that the modifications do not belong to the scope of the disclosure. The disclosure shall include meanings equivalent to the scope of the claims and all modifications within the scope.

1. An image forming apparatus, comprising:
a communicator that transmits and receives various types of data to and from a terminal device existing outside the image forming apparatus;
an image former that forms an image;
one or more controllers that control the communicator and the image former; and
a power supply controller that controls a power to be supplied to each of the communicator, the image former, and the one or more controllers, causes each of the communicator, the image former, and the one or more controllers to transition to a power saving state when a predetermined power saving transition condition is satisfied, causes each of the communicator, the image former, and the one or more controllers to transition to a silent return state not accompanied by activation of at least the image former when a predetermined silent return condition is satisfied in the power saving state, and causes each of the communicator, the image former, and the one or more controllers to return to a normal return state when a predetermined normal return condition is satisfied in the silent return state,
wherein when the communicator receives communication data based on a first communication standard determined in advance from the terminal device in the power saving state, the power supply controller causes the communicator to transition from the power saving state to the silent return state and then causes the communicator to establish connection with the terminal device based on a second communication standard determined in advance, and
when the communicator receives a normal return request determined in advance and related to communication based on the second communication standard in the silent return state, the power supply controller causes the communicator to transition from the silent return state to the normal return state.

2. The image forming apparatus according to claim 1, wherein the first communication standard is NFC, and the second communication standard is a communication standard other than NFC.

3. The image forming apparatus according to claim 2, wherein in the power saving state, the power supply controller supplies a power to only a communication circuit corresponding to the first communication standard in the communicator and thus activates the communication circuit.

4. An image forming system, comprising:
the image forming apparatus and the terminal device that are communicably connected to each other via a network according to claim 1,
wherein the terminal device includes
a terminal storage that stores a program of a job application determined in advance,
a terminal display that displays various types of information to a user,
a terminal communicator that transmits and receives various types of data to and from the image forming apparatus, and
a terminal controller that controls the terminal storage, the terminal display, and the terminal communicator, and
the terminal controller
causes the terminal display to display a first job selection screen after start of the job application,
causes the terminal communicator to establish communication with the image forming apparatus based on the second communication standard when communication data based on the first communication standard is received from the image forming apparatus, and then causes the terminal display to display a second job selection screen including a message indicating completion of connection establishment with the image forming apparatus.

5. The image forming system according to claim 4, further comprising:
a terminal operation unit that receives operation of a user,
wherein the terminal controller causes the terminal display to display a message indicating that communication connection with the image forming apparatus based on the first communication standard is to be established when the terminal operation unit receives a selection of a job on the first job selection screen after the start of the job application.

6. The image forming system according to claim 5,
wherein when the terminal operation unit receives a selection of a job accompanied by operation of the image former after completion of communication establishment with the image forming apparatus based on the second communication standard, the terminal controller causes the terminal communicator to transmit the normal return request to the image forming apparatus based on the second communication standard and then causes the terminal display to display an execution screen of the job.
